(19) United States
(12) Patent Application Publication
(10) Pub. No.: US 2008/0242152 A1
(43) Pub. Date: Oct. 2, 2008

(54) PCI EXPRESS INTERFACE CARD

(75) Inventors: CHUN-TE YEH, Tu-Cheng (TW); LI-YING CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/923,668

(22) Filed: Oct. 25, 2007

(30) Foreign Application Priority Data
Mar. 30, 2007 (CN) 200710200367.8

(51) Int. Cl. H01R 13/40

(52) U.S. Cl. 439/625

(57) ABSTRACT

A PCI Express interface card includes at least two different sized PCI Express connecting interfaces (40), at least two PCI Express buses (50) corresponding to the at least two PCI Express connecting interfaces, a controlling module (10), a switching module (20), and an indicating module (30). The at least two PCI Express connecting interfaces are used to connect with at least two corresponding PCI Express slots on a motherboard (60) to be tested. The controlling module is connected to the at least two PCI Express connecting interfaces via the at least two corresponding PCI Express buses, and communicates with the at least two PCI Express connecting interfaces. The switching module switches the controlling module to corresponding modes according to which of the PCI Express slots is connected with a corresponding PCI Express connecting interface. The indicating module is electrically connected with the controlling module, and indicates whether a test is passed.

### BACKGROUND

1. Field of the Invention

The present invention relates to testing apparatus, and particularly to a Peripheral Component Interconnect Express (PCI Express) interface card for testing PCI Express slots on a motherboard.

2. Description of Related Art

PCI Express is a revolution in graphics add-in card-interconnect standards. This specification, significantly increases bandwidth between the central processing unit and graphics processing unit by enabling balanced distribution of bandwidth to those applications that require it the most.

A connection between any two PCI Express devices is known as a “link”. The PCI Express link is built around a bidirectional, serial (1-bit), point-to-point connection known as a “lane”. Transmitting and receiving pairs are separate differential-pairs for a total of 4 data wires per lane. The PCI Express link may be comprised of multiple lanes. In such configurations, the connection is labeled as ×1, ×2, ×4, ×8, ×16, or ×32, where the number is effectively the number of lanes. Therefore, where PCI Express ×1 would require 4 wires to connect, an ×16 implementation would require 16 times that amount or 64 wires. This also results in differently sized slots. Therefore, a different PCI Express interface card is needed to test the performance of each of the different sized slots mounted on the motherboard, which wastes material and manpower, and increases the cost of testing of the motherboard.

What is needed, therefore, is to provide a low-cost PCI Express interface card which can test different sized PCI Express slots.

### SUMMARY

An exemplary PCI Express interface card includes at least two different sized PCI Express connecting interfaces, at least two PCI Express buses corresponding to the at least two PCI Express connecting interfaces, a controlling module, a switching module, and an indicating module. The at least two PCI Express connecting interfaces are used to connect with at least two corresponding PCI Express slots on a motherboard to be tested. The controlling module is connected to the at least two PCI Express connecting interfaces via the at least two corresponding PCI Express buses, and communicates with the at least two PCI Express connecting interfaces. The switching module switches the controlling module to corresponding modes according to which of the PCI Express slots is connected with a corresponding PCI Express connecting interface. The indicating module is electrically connected with the controlling module, and indicates whether a test is passed.

Other objects, advantages and novel features of the present invention will become more apparent from the following detailed description of preferred embodiments when taken in conjunction with the accompanying drawings, in which:

### BRIEF DESCRIPTION OF THE DRAWINGS

FIG. 1 is a block diagram of an embodiment of a PCI Express interface card in accordance with the present invention; and

FIG. 2 is an isometric view of the PCI Express interface card of FIG. 1, showing the PCI Express interface card attached to a PCI Express slot on a motherboard to be tested.

### DETAILED DESCRIPTION

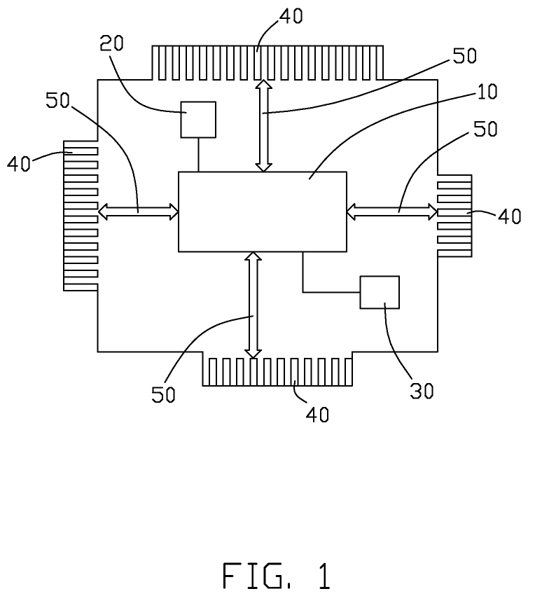

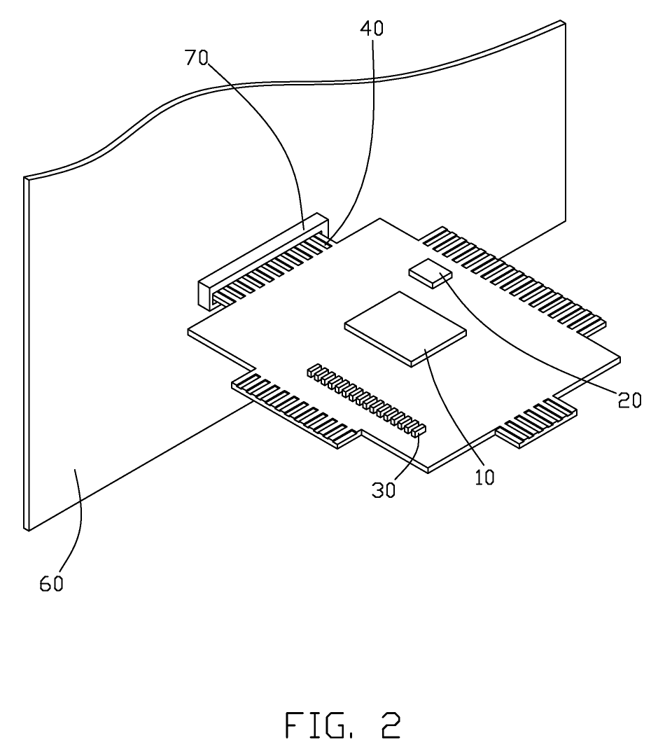

Referring to FIGS. 1 and 2, a PCI Express interface card in accordance with an embodiment of the present invention includes a controlling module 10, a switching module 20, an indicating module 30, a plurality of PCI Express connecting interfaces 40, and a plurality of PCI Express buses 50 corresponding to the plurality of PCI Express connecting interfaces 40.

In this embodiment, the PCI Express interface card is generally rectangular, and includes four connecting interfaces 40 at four sides thereof respectively. The four connecting interfaces 40 are respectively PCIE×1 connecting interface, PCIE×4 connecting interface, PCIE×8 connecting interface, and PCIE×16 connecting interface. The four connecting interfaces 40 are arranged at four edges of the PCI Express interface card and in the middle of the four edges, which are used to connect with corresponding sized PCI Express slots on a motherboard to be tested. In this embodiment, the PCIE×8 connecting interface of the PCI Express interface card is used to test a PCIE×8 slot 70 on a motherboard 60. The PCI Express interface card includes four PCI Express buses 50 which are respectively PCIE×1 bus, PCIE×4 bus, PCIE×8 bus, and PCIE×16 bus.

The controlling module 10 supports the PCIE×1, PCIE×4, PCIE×8, and PCIE×16 connecting interfaces, and is connected to the four connecting interfaces 40 via corresponding PCI Express buses 50 respectively. The controlling module 10 has basic functions of Plug-and-Play (PNP), switch modes and so on, which controls the Basic Input Output System (BIOS) to assign system resources, for example, Interrupt Request (IRQ), memory resource and so on to the PCI Express interface card.

The switching module 20 is electrically connected to the controlling module 10, to control the controlling module 10 to switch among different PCIE modes. When the PCIE×8 connecting interface of the PCI Express interface card connects with the PCIE×8 slot 70, the switching module 20 controls the controlling module 10 to switch to the PCIE×8 mode, then the controlling module 10 communicates with the PCIE×8 connecting interface via the PCIE×8 bus. In this embodiment, the switching module 20 can be a bus arbiter switching modes automatically, or a jumper that is manually controlled to switch modes.

The indicating module 30 is electrically connected to the controlling module 10, for indicating whether a test is passed. In this embodiment, the indicating module 30 includes sixteen light-emitting diodes (LEDs) which are disposed on the PCI Express interface card. Different amounts of the LEDs emit light to indicate that a corresponding PCI Express connecting interface has a good connection with a PCI Express slot to be tested. That is, the PCIE×1 connecting interface corresponding to one LED, the PCIE×4 connecting interface corresponding to four LEDs, the PCIE×8 connecting interface corresponding to eight LEDs, and the PCIE×16 connecting interface corresponding to sixteen LEDs.

When the PCI Express interface card is used to test the PCIE×8 slot 70 on the motherboard 60, the PCIE×8 connecting interface is connected with the PCIE×8 slot 70 and the motherboard 60 is powered up. The switching module 20 controls the controlling module 10 to switch to the PCIE×8 mode. The controlling module 10 communicates with the PCIE×8 connecting interface via the PCIE×8 bus. Eight LEDs of the indicating module 30 emit light to indicate the test has been passed. When the PCI Express interface card is used to test other different sized PCI Express slots on the motherboard 60, the corresponding PCI Express connecting interface 40 is connected with the PCI Express slots.

In this embodiment, the PCI Express interface card integrates different sized PCI Express connecting interfaces. The PCI Express interface card takes the place of pluralities of different sized interface cards, and can be used to test different sized PCI Express slots, which saves material, manpower, and money.

The foregoing description of the exemplary embodiment of the invention has been presented only for the purposes of illustration and description and is not intended to be exhaustive or to limit the invention to the precise forms disclosed. Many modifications and variations are possible in light of the above teaching. The embodiment was chosen and described in order to explain the principles of the invention and its practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiment described therein.

What is claimed is:

1. A PCI Express interface card, comprising:
at least two PCI Express connecting interfaces of different sizes configured for connecting with at least two corresponding PCI Express slots on a motherboard to be tested;
at least two PCI Express buses corresponding to the at least two PCI Express connecting interfaces;
a controlling module connecting and communicating with the at least two PCI Express connecting interfaces via the at least two corresponding PCI Express buses;
a switching module configured for switching the controlling module to corresponding modes according to which of the PCI Express slots connecting with a corresponding PCI Express connecting interface; and
an indicating module configured for electrically connecting with the controlling module, and indicating whether a test is passed.

2. The PCI Express interface card as claimed in claim 1, wherein the different sized PCI Express connecting interfaces comprise a PCIE×1 connecting interface, a PCIE×4 connecting interface, a PCIE×8 connecting interface, and a PCIE×16 connecting interface, the corresponding PCI Express buses comprise a PCIE×1 bus, a PCIE×4 bus, a PCIE×8 bus, and a PCIE×16 bus.

3. The PCI Express interface card as claimed in claim 2, wherein the PCIE×1 connecting interface, the PCIE×4 connecting interface, the PCIE×8 connecting interface, and the PCIE×16 connecting interface are arranged at four edges of the PCI Express interface card.

4. The PCI Express interface card as claimed in claim 2, wherein the indicating module comprises a plurality of light-emitting diodes (LEDs), different amounts of the LEDs emit light to indicate that a corresponding PCI Express connecting interface has a good connection with a PCI Express slot to be tested.

5. The PCI Express interface card as claimed in claim 1, wherein the switching module is a bus arbiter.

6. The PCI Express interface card as claimed in claim 1, wherein the switching module is a jumper.
